(19) United States
(12) Patent Application Publication
(10) Pub. No.: US 2013/0078502 A1
(43) Pub. Date: Mar. 28, 2013

(54) INJECTION MOLDING COMPOSITION AND ARTICLE

(71) Applicant: Geoffrey Henry Riding, Castleton, NY (US)

(72) Inventor: Geoffrey Henry Riding, Castleton, NY (US)

(21) Appl. No.: 13/247,110

(22) Filed: Sep. 28, 2011

(51) Int. Cl. H01M 2/02; C08L 25/06; C08L 53/02; B29C 45/00; C08L 23/06; C08L 25/12; C08L 27/18; B32B 3/00; C08K 5/523; C08L 71/10

(52) U.S. Cl. 429/163; 524/127; 428/220; 264/328.1

(57) ABSTRACT

An injection molding composition includes specific amounts of a poly(arylene ether), a rubber-modified polystyrene, a bisphenol bis(diaryl phosphate), and a hydrogenated block copolymer of an alkenyl aromatic compound and a conjugated diene. The composition exhibits improved hydrolysis resistance and is useful for injection molding lead acid battery cases that exhibit improved hydrolysis resistance when employed use in hot, humid environments.

### BACKGROUND

Large lead acid batteries are widely used as backup power sources for cell phone towers. A critical performance issue for plastics intended for use in large lead acid battery housing applications is the need to prevent distortion of the battery housing walls when the battery experiences elevated temperatures, for example when a high battery recharge rate is applied, or when the battery is used in hot climates.

The plastic used in large lead acid battery cases also must exhibit excellent impact resistance to prevent failures due to brittleness when, as part of the battery assembly process, holes are punched through the molded-in cell dividers in order to make connections between electrodes located in adjoining individual cells. In addition, the large, thin sections of these battery cases present a challenge for successful molding operations. For example the resin must have a melt flow rate sufficient to avoid processing problems such as distorted cell dividers or short shots in which the mold is not completely filled.

Resins for use in large lead acid battery cases thus require a combination of high melt flow to fill the part, high impact strength to avoid cracking when the holes are punched for the inter-cell connections, high heat distortion temperatures to avoid warping during high discharge rates and warmer climates, and good hydrolysis resistance for long-term use, especially in humid climates. Recently, it has been observed that plastic compositions that provide sufficient melt flow, impact strength, and heat resistance are deficient in their hydrolysis resistance. There is therefore a need for plastic compositions that exhibit improved hydrolysis resistance while maintaining desired levels of melt flow, impact strength, and heat resistance.

### BRIEF SUMMARY OF EMBODIMENTS OF THE INVENTION

One embodiment is a composition comprising: about 53 to about 63 weight percent of a poly(arylene ether) having an intrinsic viscosity of about 0.34 to about 0.48 deciliter/gram measured at 25° C. in chloroform; about 15 to about 25 weight percent of a rubber-modified polystyrene; about 11 to about 18 weight percent of a bisphenol bis(diaryl phosphate); and about 1 to about 4 weight percent of a hydrogenated block copolymer of an alkenyl aromatic compound and a conjugated diene; wherein all weight percents are based on the total weight of the composition.

Another embodiment is an injection molded article comprising the above-described composition; wherein a portion of the injection molded article comprises a first dimension of at least 10 centimeters, a second dimension of at least 10 centimeters, and a third dimension of less than 1 centimeter.

Another embodiment is a method of improving the hydrolytic stability of an injection molded article comprising a poly(arylene ether) composition, the method comprising: injection molding the above-describe composition to form an injection molded article; wherein a portion of the injection molded article comprises a first dimension of at least 10 centimeters, a second dimension of at least 10 centimeters, and a third dimension of less than 1 centimeter.

Another embodiment is a composition comprising: about 55 to about 60 weight percent of a poly(2,6-dimethyl-1,4-phenylene ether) having an intrinsic viscosity of about 0.37 to about 0.43 deciliter/gram measured at 25° C. in chloroform; about 17 to about 23 weight percent of a high impact polystyrene; about 13 to about 17 weight percent of bisphenol A bis(diphenyl phosphate); about 1.5 to about 5 weight percent of a hydrogenated aliphatic hydrocarbon resin; and about 1 to about 3 weight percent of a polystyrene-poly(ethylene-butylene)-polystyrene triblock copolymer; wherein all weight percents are based on the total weight of the poly(arylene ether) composition.

These and other embodiments are described in detail below.

### BRIEF DESCRIPTION OF THE DRAWING

FIG. 1 is a chemical scheme for the preparation of a poly(arylene ether) by oxidative polymerization of 2,6-dimethylphenol to yield poly(2,6-dimethyl-1,4-phenylene ether) and 3,3′,5,5′-tetramethyldiphenoquinone; reequilibration of the reaction mixture can produce a poly(arylene ether) with terminal and internal residues of incorporated diphenoquinone.

### DETAILED DESCRIPTION OF THE INVENTION

The present inventor has determined that an improved balance of hydrolysis resistance, melt flow, impact strength, and heat resistance is exhibited by a composition comprising: about 53 to about 63 weight percent of a poly(arylene ether) having an intrinsic viscosity of about 0.34 to about 0.48 deciliter/gram measured at 25° C. in chloroform; about 15 to about 25 weight percent of a rubber-modified polystyrene; about 11 to about 18 weight percent of a bisphenol bis(diaryl phosphate); and about 1 to about 4 weight percent of a hydrogenated block copolymer of an alkenyl aromatic compound and a conjugated diene; wherein all weight percents are based on the total weight of the composition.

The composition comprises a poly(arylene ether). Suitable poly(arylene ether)s include those comprising repeating structural units having the formula

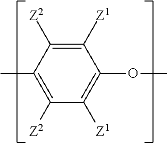

wherein each occurrence of Z¹ is independently halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and each occurrence of Z² is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms. As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. As one example, Z¹ can be a di-n-butylaminomethyl group formed by reaction of a terminal 3,5-dimethyl-1,4-phenyl group with the di-n-butylamine component of an oxidative polymerization catalyst.

The poly(arylene ether) has an intrinsic viscosity of about 0.34 to about 0.48 deciliter/gram measured at 25° C. in chloroform. Within this range, the poly(arylene ether) intrinsic viscosity can be about 0.36 to about 0.46 deciliter per gram, more specifically about 0.37 to about 0.43 deciliter per gram.

In some embodiments, the poly(arylene ether) is a poly(2,6-dimethyl-1,4-phenylene ether) prepared with a morpholine-containing catalyst, wherein a purified sample of poly(2,6-dimethyl-1,4-phenylene ether) prepared by dissolution of the poly(2,6-dimethyl-1,4-phenylene ether) in toluene, precipitation from methanol, reslurry, and isolation has a monomodal molecular weight distribution in the molecular weight range of 250 to 1,000,000 atomic mass units, and comprises less than or equal to 2.2 weight percent of poly(2,6-dimethyl-1,4-phenylene ether) having a molecular weight more than fifteen times the number average molecular weight of the entire purified sample. In some embodiments, the purified sample after separation into six equal poly(2,6-dimethyl-1,4-phenylene ether) weight fractions of decreasing molecular weight comprises a first, highest molecular weight fraction comprising at least 10 mole percent of poly(2,6-dimethyl-1,4-phenylene ether) comprising a terminal morpholine-substituted phenoxy group. The poly(2,6-dimethyl-1,4-phenylene ether) according to these embodiments is further described in U.S. Patent Application Publication No. US 2011/0003962 A1 of Carrillo et al.

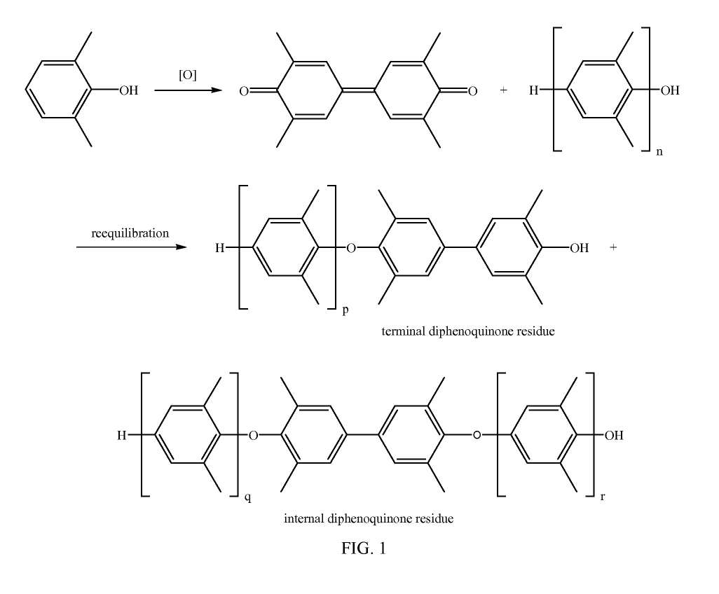

In some embodiments, the poly(arylene ether) is essentially free of incorporated diphenoquinone residues. In the context, “essentially free” means that the fewer than 1 weight percent of poly(arylene ether) molecules comprise the residue of a diphenoquinone. As described in U.S. Pat. No. 3,306,874 to Hay, synthesis of poly(arylene ether) by oxidative polymerization of monohydric phenol yields not only the desired poly(arylene ether) but also a diphenoquinone as side product. For example, when the monohydric phenol is 2,6-dimethylphenol, 3,3′,5,5′-tetramethyldiphenoquinone is generated. Typically, the diphenoquinone is “reequilibrated” into the poly(arylene ether) (i.e., the diphenoquinone is incorporated into the poly(arylene ether) structure) by heating the polymerization reaction mixture to yield a poly(arylene ether) comprising terminal or internal diphenoquinone residues. For example, as shown in FIG. 1, when a poly(arylene ether) is prepared by oxidative polymerization of 2,6-dimethylphenol to yield poly(2,6-dimethyl-1,4-phenylene ether) and 3,3′,5,5′-tetramethyldiphenoquinone, reequilibration of the reaction mixture can produce a poly(arylene ether) with terminal and internal residues of incorporated diphenoquinone. However, such reequilibration reduces the molecular weight of the poly(arylene ether) (e.g., p and q+r are less than n). Accordingly, when a higher molecular weight poly(arylene ether) is desired, it may be desirable to separate the diphenoquinone from the poly(arylene ether) rather than reequilibrating the diphenoquinone into the poly(arylene ether) chains. Such a separation can be achieved, for example, by precipitation of the poly(arylene ether) in a solvent or solvent mixture in which the poly(arylene ether) is insoluble and the diphenoquinone is soluble. For example, when a poly(arylene ether) is prepared by oxidative polymerization of 2,6-dimethylphenol in toluene to yield a toluene solution comprising poly(2,6-dimethyl-1,4-phenylene ether) and 3,3′,5,5′-tetramethyldiphenoquinone, a poly(2,6-dimethyl-1,4-phenylene ether) essentially free of diphenoquinone can be obtained by mixing 1 volume of the toluene solution with about 1 to about 4 volumes of methanol or a methanol/water mixture. Alternatively, the amount of diphenoquinone side-product generated during oxidative polymerization can be minimized (e.g., by initiating oxidative polymerization in the presence of less than 10 weight percent of the monohydric phenol and adding at least 95 weight percent of the monohydric phenol over the course of at least 50 minutes), and/or the reequilibration of the diphenoquinone into the poly(arylene ether) chain can be minimized (e.g., by isolating the poly(arylene ether) no more than 200 minutes after termination of oxidative polymerization). These approaches are described in International Patent Application Publication No. WO2009/104107 A1 of Delsman et al. In an alternative approach utilizing the temperature-dependent solubility of diphenoquinone in toluene, a toluene solution containing diphenoquinone and poly(arylene ether) can be adjusted to a temperature of about 25° C., at which diphenoquinone is poorly soluble but the poly(arylene ether) is soluble, and the insoluble diphenoquinone can be removed by solid-liquid separation (e.g., filtration).

In some embodiments, the poly(arylene ether) comprises 2,6-dimethyl-1,4-phenylene ether units, 2,3,6-trimethyl-1,4-phenylene ether units, or a combination thereof. In some embodiments, the poly(arylene ether) is a poly(2,6-dimethyl-1,4-phenylene ether). In some embodiments, the poly(arylene ether) comprises a poly(2,6-dimethyl-1,4-phenylene ether) having an intrinsic viscosity of about 0.34 to about 0.48 deciliter per gram, specifically about 0.36 to about 0.46 deciliter per gram, more specifically about 0.37 to about 0.43 deciliter per gram, measured at 25° C. in chloroform.

The poly(arylene ether) can comprise molecules having aminoalkyl-containing end group(s), typically located in a position ortho to the hydroxy group. Also frequently present are tetramethyldiphenoquinone (TMDQ) end groups, typically obtained from 2,6-dimethylphenol-containing reaction mixtures in which tetramethyldiphenoquinone by-product is present. The poly(arylene ether) can be in the form of a homopolymer, a copolymer, a graft copolymer, an ionomer, or a block copolymer, as well as combinations comprising at least one of the foregoing.

The thermoplastic composition comprises the poly(arylene ether) in an amount of about 53 to about 63 weight percent, based on the total weight of the thermoplastic composition. Within this range, the poly(arylene ether) amount can be about 55 to about 60 weight percent, more specifically about 56 to about 59 weight percent.

In addition to the poly(arylene ether), the composition comprises a rubber-modified polystyrene. The rubber-modified polystyrene comprises polystyrene and polybutadiene. Rubber-modified polystyrenes are sometimes referred to as “high-impact polystyrenes” or “HIPS”. In some embodiments, the rubber-modified polystyrene comprises 80 to 96 weight percent polystyrene, specifically 88 to 94 weight percent polystyrene; and 4 to 20 weight percent polybutadiene, specifically 6 to 12 weight percent polybutadiene, based on the weight of the rubber-modified polystyrene. In some embodiments, the rubber-modified polystyrene has an effective gel content of 10 to 35 percent. Suitable rubber-modified polystyrenes are commercially available as, for example, HIPS3190 from SABIC Innovative Plastics.

The composition comprises the rubber-modified polystyrene in an amount of about 15 to about 25 weight percent, specifically about 17 to about 23 weight percent, more specifically about 19 to about 21 weight percent, based on the total weight of the composition.

In addition to the poly(arylene ether) and the rubber-modified polystyrene, the composition comprises a bisphenol bis(diaryl phosphate). In some embodiments, the bisphenol bis(diaryl phosphate) has the structure

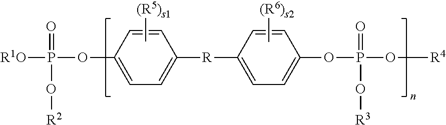

wherein R is independently at each occurrence a C₁-C₁₂ alkylene group; R⁵ and R⁶ are independently at each occurrence a C₁-C₅ alkyl group; R¹, R², and R⁴ are independently a C₆-C₁₂ unsubstituted or substituted aryl group; R³ is independently at each occurrence a C₆-C₁₂ unsubstituted or substituted aryl group; n is 1 to 25; and s1 and s2 are independently 0, 1, or 2.

As readily appreciated by one of ordinary skill in the art, the bis-aryl phosphate is derived from a bisphenol. Exemplary bisphenols include 2,2-bis(4-hydroxyphenyl)propane (so-called bisphenol A), 2,2-bis(4-hydroxy-3-methylphenyl)propane, bis(4-hydroxyphenyl)methane, bis(4-hydroxy-3,5-dimethylphenyl)methane and 1,1-bis(4-hydroxyphenyl)ethane. In some embodiments, the bisphenol comprises bisphenol A.

In some embodiments, the bisphenol bis(diaryl phosphate) comprises bisphenol A bis(diphenyl phosphate).

The composition comprises the bisphenol bis(diaryl phosphate) in an amount of about 11 to about 18 weight percent, based on the total weight of the composition. Within this range, the bisphenol bis(diaryl phosphate) amount can be about 13 to about 17 weight percent.

In addition to the poly(arylene ether), the rubber-modified polystyrene, and the bisphenol bis(diaryl phosphate), the composition comprises a hydrogenated block copolymer of an alkenyl aromatic compound and a conjugated diene. For brevity, this component is referred to as the “hydrogenated block copolymer”. The hydrogenated block copolymer can comprise about 10 to about 90 weight percent of poly(alkenyl aromatic) content and about 90 to about 10 weight percent of hydrogenated poly(conjugated diene) content, based on the weight of the hydrogenated block copolymer. In some embodiments, the hydrogenated block copolymer is a low poly(alkenyl aromatic content) hydrogenated block copolymer in which the poly(alkenyl aromatic) content is about 10 to less than 40 weight percent, specifically about 20 to about 35 weight percent, more specifically about 25 to about 35 weight percent, yet more specifically about 30 to about 35 weight percent, all based on the weight of the low poly(alkenyl aromatic content) hydrogenated block copolymer. In other embodiments, the hydrogenated block copolymer is a high poly(alkenyl aromatic content) hydrogenated block copolymer in which the poly(alkenyl aromatic) content is 40 to about 90 weight percent, specifically about 50 to about 80 weight percent, more specifically about 60 to about 70 weight percent, all based on the weight of the high poly(alkenyl aromatic content) hydrogenated block copolymer.

In some embodiments, the hydrogenated block copolymer has a weight average molecular weight of about 40,000 to about 400,000 atomic mass units. The number average molecular weight and the weight average molecular weight can be determined by gel permeation chromatography and based on comparison to polystyrene standards. In some embodiments, the hydrogenated block copolymer has a weight average molecular weight of about 200,000 to about 400,000 atomic mass units, specifically about 220,000 to about 350,000 atomic mass units. In other embodiments, the hydrogenated block copolymer has a weight average molecular weight of about 40,000 to about 200,000 atomic mass units, specifically about 40,000 to about 180,000 atomic mass units, more specifically about 40,000 to about 150,000 atomic mass units.

The alkenyl aromatic monomer used to prepare the hydrogenated block copolymer can have the structure

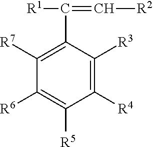

wherein R¹ and R² each independently represent a hydrogen atom, a C₁-C₈ alkyl group, or a C₂-C₈ alkenyl group; R³ and R⁷ each independently represent a hydrogen atom, a C₁-C₈ alkyl group, a chlorine atom, or a bromine atom; and R⁴, R⁵, and R⁶ each independently represent a hydrogen atom, a C₁-C₈ alkyl group, or a C₂-C₈ alkenyl group, or R⁴ and R⁵ are taken together with the central aromatic ring to form a naphthyl group, or R⁵ and R⁶ are taken together with the central aromatic ring to form a naphthyl group. Specific alkenyl aromatic monomers include, for example, styrene, chlorostyrenes such as p-chlorostyrene, methylstyrenes such as alpha-methylstyrene and p-methylstyrene, and t-butylstyrenes such as 3-t-butylstyrene and 4-t-butylstyrene. In some embodiments, the alkenyl aromatic monomer is styrene.

The conjugated diene used to prepare the hydrogenated block copolymer can be a C₄-C₂₀ conjugated diene. Suitable conjugated dienes include, for example, 1,3-butadiene, 2-methyl-1,3-butadiene, 2-chloro-1,3-butadiene, 2,3-dimethyl-1,3-butadiene, 1,3-pentadiene, 1,3-hexadiene, and the like, and combinations thereof. In some embodiments, the conjugated diene is 1,3-butadiene, 2-methyl-1,3-butadiene, or a combination thereof. In some embodiments, the conjugated diene consists of 1,3-butadiene.

The hydrogenated block copolymer is a copolymer comprising (A) at least one block derived from an alkenyl aromatic compound and (B) at least one block derived from a conjugated diene, in which the aliphatic unsaturated group content in the block (B) is at least partially reduced by hydrogenation. In some embodiments, the aliphatic unsaturation in the (B) block is reduced by at least 50 percent, specifically at least 70 percent. The arrangement of blocks (A) and (B) includes a linear structure, a grafted structure, and a radial teleblock structure with or without a branched chain. Linear block copolymers include tapered linear structures and non-tapered linear structures. In some embodiments, the hydrogenated block copolymer has a tapered linear structure. In some embodiments, the hydrogenated block copolymer has a non-tapered linear structure. In some embodiments, the hydrogenated block copolymer comprises a (B) block that comprises random incorporation of alkenyl aromatic monomer. Linear block copolymer structures include diblock (A-B block), triblock (A-B-A block or B-A-B block), tetrablock (A-B-A-B block), and pentablock (A-B-A-B-A block or B-A-B-A-B block) structures as well as linear structures containing 6 or more blocks in total of (A) and (B), wherein the molecular weight of each (A) block can be the same as or different from that of other (A) blocks, and the molecular weight of each (B) block can be the same as or different from that of other (B) blocks. In some embodiments, the hydrogenated block copolymer is a diblock copolymer, a triblock copolymer, or a combination thereof.

In some embodiments, the hydrogenated block copolymer excludes the residue of monomers other than the alkenyl aromatic compound and the conjugated diene. In some embodiments, the hydrogenated block copolymer consists of blocks derived from the alkenyl aromatic compound and the conjugated diene. It does not comprise grafts formed from these or any other monomers. It also consists of carbon and hydrogen atoms and therefore excludes heteroatoms. In some embodiments, the hydrogenated block copolymer includes the residue of one or more acid functionalizing agents, such as maleic anhydride. In some embodiments, the hydrogenated block copolymer comprises a polystyrene-poly(ethylene-butylene)-polystyrene triblock copolymer. In some embodiments, the hydrogenated block copolymer comprises a polystyrene-poly(ethylene-butylene)-polystyrene triblock copolymer having a weight average molecular weight of about 200,000 to about 400,000 atomic mass units, specifically about 220,000 to about 350,000 atomic mass units.

Methods for preparing hydrogenated block copolymers are known in the art and many hydrogenated block copolymers are commercially available. Illustrative commercially available hydrogenated block copolymers include the polystyrene-poly(ethylene-propylene) diblock copolymers available from Kraton Polymers as KRATON G1701 and G1702; the polystyrene-poly(ethylene-butylene)-polystyrene triblock copolymers available from Kraton Polymers as KRATON G1641, G1650, G1651, G1654, G1657, G1726, G4609, G4610, GRP-6598, RP-6924, MD-6932M, MD-6933, and MD-6939; the polystyrene-poly(ethylene-butylene-styrene)-polystyrene (S-EB/S-S) triblock copolymers available from Kraton Polymers as KRATON RP-6935 and RP-6936, the polystyrene-poly(ethylene-propylene)-polystyrene triblock copolymers available from Kraton Polymers as KRATON G1730; the maleic anhydride-grafted polystyrene-poly(ethylene-butylene)-polystyrene triblock copolymers available from Kraton Polymers as KRATON G1901, G1924, and MD-6684; the maleic anhydride-grafted polystyrene-poly(ethylene-butylene-styrene)-polystyrene triblock copolymer available from Kraton Polymers as KRATON MD-6670; the polystyrene-poly(ethylene-butylene)-polystyrene triblock copolymer comprising 67 weight percent polystyrene available from Asahi Kasei Elastomer as TUFTEC H1043; the polystyrene-poly(ethylene-butylene)-polystyrene triblock copolymer comprising 42 weight percent polystyrene available from Asahi Kasei Elastomer as TUFTEC H1051; the polystyrene-poly(butadiene-butylene)-polystyrene triblock copolymers available from Asahi Kasei Elastomer as TUFTEC P1000 and P2000; the polystyrene-poly(ethylene-butylene)-polystyrene triblock copolymer comprising 60 weight polystyrene available from Kuraray as SEPTON 58104; the polystyrene-poly(ethylene-ethylene/propylene)-polystyrene triblock copolymers available from Kuraray as SEPTON S4044, S4055, S4077, and S4099; and the polystyrene-poly(ethylene-propylene)-polystyrene triblock copolymer comprising 65 weight percent polystyrene available from Kuraray as SEPTON S2104. Mixtures of two of more hydrogenated block copolymers can be used.

The composition comprises a hydrogenated block copolymer in an amount of about 1 to about 4 weight percent, specifically about 1.4 to about 3 weight percent, more specifically about 1.7 to about 2.5 weight percent, based on the total weight of the composition.

In some embodiments, the composition further comprises a mold release agent. Suitable mold release agents include, for example, pentaerythritol esters, such as tetrastearate; montanic acid esters; linear low density polyethylenes; and combinations thereof. In some embodiments, the mold release agent comprises linear low density polyethylene. When present, the mold release agent can be used in an amount of about 0.5 to about 3 weight percent, specifically about 1 to about 2 weight percent, based on the total weight of the composition.

In some embodiments, the composition further comprises a drip retardant. A particularly suitable drip retardant is poly(styrene-acrylonitrile)-encapsulated polytetrafluoroethylene. Polytetrafluoroethylene (PTFE) encapsulated in styrene-acrylonitrile copolymer (SAN) is known as T-SAN. T-SAN can be made by polymerizing styrene and acrylonitrile in the presence of polytetrafluoroethylene. In some embodiments, the poly(styrene-acrylonitrile)-encapsulated polytetrafluoroethylene can comprise about 30 to about 70 weight percent polytetrafluoroethylene and about 30 to about 70 weight percent poly(styrene-acrylonitrile), based on the weight of the poly(styrene-acrylonitrile)-encapsulated polytetrafluoroethylene. In some embodiments, the encapsulating poly(styrene-acrylonitrile) comprises about 50 to about 90 weight percent styrene residues, and about 10 to about 50 weight percent acrylonitrile residues. When present in the composition, the drip retardant can be used in an amount of about 0.02 to about 2 weight percent, specifically about 0.05 to about 1 weight percent, more specifically about 0.05 to about 0.5 weight percent, based on the total weight of the composition.

In some embodiments, the composition further comprises a hydrocarbon resin. Examples of hydrocarbon resins are aliphatic hydrocarbon resins, hydrogenated aliphatic hydrocarbon resins, aliphatic/aromatic hydrocarbon resins, hydrogenated aliphatic/aromatic hydrocarbon resins, cycloaliphatic hydrocarbon resins, hydrogenated cycloaliphatic resins, cycloaliphatic/aromatic hydrocarbon resins, hydrogenated cycloaliphatic/aromatic hydrocarbon resins, hydrogenated aromatic hydrocarbon resins, polyterpene resins, terpene-phenol resins, rosins and rosin esters, hydrogenated rosins and rosin esters, and mixtures thereof. As used herein, “hydrogenated”, when referring to the hydrocarbon resin, includes fully, substantially, and partially hydrogenated resins. Suitable aromatic resins include aromatic modified aliphatic resins, aromatic modified cycloaliphatic resins, and hydrogenated aromatic hydrocarbon resins having an aromatic content of about 1 to about 30 weight percent. Any of the above resins may be grafted with an unsaturated ester or anhydride using methods known in the art. Such grafting can provide enhanced properties to the resin. In one embodiment, the hydrocarbon resin is a hydrogenated aromatic hydrocarbon resin.

Suitable hydrocarbon resins are commercially available and include, for example, EMPR 100, 101, 102, 103, 104, 105, 106, 107, 108, 109, 110, 116, 117, and 118 resins, and OPPERA resins, available from ExxonMobil Chemical Company; ARKON P140, P125, P115, M115, and M135, and SUPER ESTER rosin esters available from Arakawa Chemical Company of Japan; SYLVARES polyterpene resins, styrenated terpene resins and terpene phenolic resins available from Arizona Chemical Company; SYLVATAC and SYLVALITE rosin esters available from Arizona Chemical Company; NORSOLENE aliphatic aromatic resins available from Cray Valley; DERTOPHENE terpene phenolic resins and DERCOLYTE polyterpene resins available from DRT Chemical Company; EASTOTAC resins, PICCOTAC resins, REGALITE and REGALREZ hydrogenated cycloaliphatic/aromatic resins, and PICCOLYTE and PERMALYN polyterpene resins, rosins, and rosin esters available from Eastman Chemical Company; WINGTACK resins available from Goodyear Chemical Company; coumarone/indene resins available from Neville Chemical Company; QUINTONE acid modified C5 resins, C5/C9 resins, and acid-modified C5/C9 resins available from Nippon Zeon; and CLEARON hydrogenated terpene resins available from Yasuhara.

In some embodiments, the hydrocarbon resins have softening points of about 80 to about 180° C., specifically about 100 to about 170° C., more specifically about 110 to about 150° C., and still more specifically about 120 to about 130° C. Softening point is measured as a ring and ball softening point according to ASTM E28-99. A specific hydrocarbon resin is ARKON P125, which has a softening point of about 125° C.

When present in the composition, the hydrocarbon resin can be used in an amount of about 0.5 to about 6 weight percent, specifically about 1 to about 5 weight percent, and more specifically about 2 to about 4 weight percent, based on the total weight of the composition.

In some embodiments, the composition further comprises an aryl phosphite. In general, the aryl phosphite is a phosphite comprising at least one aryloxy group covalently bound to a phosphitic phosphorus atom. In some embodiments, the aryl phosphite has the structure P(OR¹)₃, wherein each occurrence of R¹ is independently C₁-C₂₄ hydrocarbyl, provided that at least one occurrence of R¹ is an unsubstituted or substituted C₆-C₂₄ aryl. In some embodiments, each occurrence of R¹ is independently an unsubstituted or substituted C₆-C₂₄ aryl. In some embodiments, the aryl phosphite comprises tris(2,4-di-tert-butylphenyl)phosphite (CAS Reg. No. 31570-04-4). When present in the composition, the aryl phosphite can be used in an amount of about 0.05 to about 1 weight percent, specifically about 0.1 to about 0.6 weight percent, more specifically about 0.15 to about 0.4 weight percent, based on the weight of the composition.

In a very specific embodiment, the composition comprises about 55 to about 60 weight percent of a poly(2,6-dimethyl-1,4-phenylene ether) having an intrinsic viscosity of about 0.37 to about 0.43 deciliter/gram measured at 25° C. in chloroform; about 17 to about 23 weight percent of a high impact polystyrene; about 13 to about 17 weight percent of bisphenol A bis(diphenyl phosphate); about 1.5 to about 5 weight percent of a hydrogenated aliphatic hydrocarbon resin; about 1 to about 3 weight percent of a polystyrene-poly(ethylene-butylene)-polystyrene triblock copolymer; wherein all weight percents are based on the total weight of the poly(arylene ether) composition. The composition can, optionally, further comprise about 0.5 to about 3 weight percent of a linear low density polyethylene; about 0.05 to about 1 weight percent of tris(2,4-di-tert-butylphenyl)phosphite; and about 0.02 to about 0.5 weight percent of a poly(styrene-acrylonitrile)-encapsulated polytetrafluoroethylene.

The composition can, optionally, exclude polymers not described above as required or optional. For example, the composition can, optionally, exclude one or more of homopolystyrene, unhydrogenated block copolymers of alkenyl aromatic compounds and conjugated dienes, polyamides, polyesters, and polyolefins other than the linear low density polyethylene optionally used as a mold release agent.

The composition is particularly suited for injection molding parts having large, flat sections, such as, for example, cases for lead acid batteries, especially those used to provide back-up power to cell phone towers. Thus, one embodiment is an injection molded article comprising any of the above-described embodiments of the composition; wherein a portion of the injection molded article comprises a first dimension of at least 10 centimeters, a second dimension of at least 10 centimeters, and a third dimension of less than 1 centimeter.

Another embodiment is a method of improving the hydrolytic stability of an injection molded article comprising a poly(arylene ether) composition, the method comprising: injection molding any of the above-described embodiments of the composition to form an injection molded article; wherein a portion of the injection molded article comprises a first dimension of at least 10 centimeters, a second dimension of at least 10 centimeters, and a third dimension of less than 1 centimeter.

The invention includes at least the following embodiments.

Embodiment 1: A composition comprising: about 53 to about 63 weight percent of a poly(arylene ether) having an intrinsic viscosity of about 0.34 to about 0.48 deciliter/gram measured at 25° C. in chloroform; about 15 to about 25 weight percent of a rubber-modified polystyrene; about 11 to about 18 weight percent of a bisphenol bis(diaryl phosphate); and about 1 to about 4 weight percent of a hydrogenated block copolymer of an alkenyl aromatic compound and a conjugated diene; wherein all weight percents are based on the total weight of the composition.

Embodiment 2: The composition of embodiment 1, wherein the poly(arylene ether) is a poly(2,6-dimethyl-1,4-phenylene ether) having an intrinsic viscosity of about 0.37 to about 0. 0.43 deciliter/gram measured at 25° C. in chloroform.

Embodiment 3: The composition of embodiment 1 or 2, wherein the bisphenol bis(diaryl phosphate) has the structure

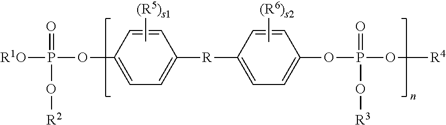

wherein R is independently at each occurrence a C₁-C₁₂ alkylene group; R⁵ and R⁶ are independently at each occurrence a C₁-C₅ alkyl group; R¹, R², and R⁴ are independently a C₆-C₁₂ unsubstituted or substituted aryl group; R³ is independently at each occurrence a C₆-C₁₂ unsubstituted or substituted aryl group; n is 1 to 25; and s1 and s2 are independently 0, 1, or 2.

Embodiment 4: The composition of any of embodiments 1-3, wherein the bisphenol bis(diaryl phosphate) comprises bisphenol A bis(diphenyl phosphate).

Embodiment 5: The composition of any of embodiments 1-4, wherein the hydrogenated block copolymer comprises a polystyrene-poly(ethylene-butylene)-polystyrene triblock copolymer.

Embodiment 6: The composition of any of embodiments 1-5, further comprising about 0.5 to about 3 weight percent of a mold release agent.

Embodiment 7: The composition of embodiment 6, wherein the mold release agent comprises linear low density polyethylene.

Embodiment 8: The composition of any of embodiments 1-7, further comprising about 0.02 to about 2 weight percent of a drip control agent.

Embodiment 9: The composition of embodiment 8, wherein the drip control agent comprises poly(styrene-acrylonitrile)-encapsulated polytetrafluoroethylene.

Embodiment 10: The composition of any of embodiments 1-9, further comprising about 0.5 to about 6 weight percent of a hydrocarbon resin.

Embodiment 11: The composition of embodiment 10, wherein the hydrocarbon resin comprises a hydrogenated aliphatic hydrocarbon resin.

Embodiment 12: The composition of any of embodiments 1-11, further comprising about 0.05 to about 1 weight percent of an aryl phosphite.

Embodiment 13: The composition of embodiment 12, wherein the aryl phosphite comprises tris(2,4-di-tert-butylphenyl)phosphite.

Embodiment 14: A composition comprising: about 55 to about 60 weight percent of a poly(2,6-dimethyl-1,4-phenylene ether) having an intrinsic viscosity of about 0.37 to about 0.43 deciliter/gram measured at 25° C. in chloroform; about 17 to about 23 weight percent of a high impact polystyrene; about 13 to about 17 weight percent of bisphenol A bis(diphenyl phosphate); about 1.5 to about 5 weight percent of a hydrogenated aliphatic hydrocarbon resin; and about 1 to about 3 weight percent of a polystyrene-poly(ethylene-butylene)-polystyrene triblock copolymer; wherein all weight percents are based on the total weight of the poly(arylene ether) composition.

Embodiment 15: The composition of embodiment 14, further comprising about 0.5 to about 3 weight percent of a linear low density polyethylene; about 0.05 to about 1 weight percent of tris(2,4-di-tert-butylphenyl)phosphite; and about 0.02 to about 0.5 weight percent of a poly(styrene-acrylonitrile)-encapsulated polytetrafluoroethylene.

Embodiment 16: An injection molded article comprising the composition of embodiment 1; wherein a portion of the injection molded article comprises a first dimension of at least 10 centimeters, a second dimension of at least 10 centimeters, and a third dimension of less than 1 centimeter.

Embodiment 17: The injection molded article of embodiment 16, comprising the composition of embodiment 14.

Embodiment 18: The injection molded article of embodiment 16, wherein the injection molded article is a case for a lead acid battery.

Embodiment 19: A method of improving the hydrolytic stability of an injection molded article comprising a poly(arylene ether) composition, the method comprising: injection molding the composition of embodiment 1 to form an injection molded article; wherein a portion of the injection molded article comprises a first dimension of at least 10 centimeters, a second dimension of at least 10 centimeters, and a third dimension of less than 1 centimeter.

Embodiment 20: The method of embodiment 19, wherein said injection molding comprising injection molding the composition of embodiment 14.

Embodiment 21: The method of embodiment 19, wherein the injection molded article is a case for a lead acid battery.

The invention is further illustrated by the following non-limiting examples.

### EXAMPLE 1, COMPARATIVE EXAMPLES A-C

Thermoplastic compositions were compounded using the components listed in Table 1.

TABLE 1

| Component | |
|---|---|
| Designation | Description |
| PPE 0.46 | Poly(2,6-dimethyl-1,4-phenylene ether), CAS Reg. No. 24938-67-8; |
| | having an intrinsic viscosity of about 0.46 deciliter per gram as |
| | measured in chloroform at 25° C.; obtained as PPO 646 from SABIC |
| | Innovative Plastics. |
| PPE 0.40 | Poly(2,6-dimethyl-1,4-phenylene ether), CAS Reg. No. 24938-67-8; |
| | having an intrinsic viscosity of about 0.46 deciliter per gram as |
| | measured in chloroform at 25° C.; obtained as PPO 640 from SABIC |
| | Innovative Plastics. |
| Hydrocarbon | Hydrogenated aliphatic hydrocarbon resin, CAS Reg. No. |
| Resin | 123465-34-9; obtained as ARKON P-125 from Arakawa Chemical in |
| | pellet form and ground to a powder before use. |
| ZnS | Zinc sulfide, CAS Reg. No. 1314-98-3; obtained as SACHTOLITH |
| | HD-S from Sachtleben Chemie GmbH. |
| ZnO | Zinc oxide, CAS Reg. No. 1314-13-2; obtained as Zinkweiss |
| | Harzsiegel CF from Norzinco GmbH or as Zinc Oxide CR-4 from |
| | G.H. Chemical. |
| MgO | Magnesium oxide, CAS Reg. No. 1309-48-4; obtained as |
| | KYOWAMAG 150 from Kyowa Chemical Co. Ltd. |
| BPADP | Bisphenol A bis(diphenyl phosphate), CAS Reg. No. 181028-79-5; |
| | obtained as CR-741 from Daihachi Chemical, as FYROLFLEX BDP |
| | from Supresta LLC, or as REOFOS BAPP from Great Lakes Chemical Co. Ltd. |
| RDP | Resorcinol bis(diphenyl phosphate), CAS Reg. No. 57583-54-7; |
| | obtained as CR-733S from Daihachi Chemical., as FYROLFLEX RDP |
| | from Supresta LLC, or as REOFOS RDP from Great Lakes Chemical Co. Ltd. |
| SEBS | Polystyrene-poly(ethylene-butylene)-polystyrene triblock copolymer, |
| | CAS Reg. No. 66070-58-4, having a polystyrene content of about 33 |
| | weight percent; obtained as KRATON G1651 from Kraton Polymers. |
| SBS | Polystyrene-polybutadiene-polystyrene triblock copolymer having a |
| | styrene content of 31 weight percent; obtained as VECTOR 2518 from |
| | Dexco Polymers. |
| T-SAN | Poly(styrene-acrylonitrile)-encapsulated polytetrafluoroethylene; |
| | obtained as INP449 from SABIC Innovative Plastics. |
| LLDPE | Linear low density polyethylene, CAS Reg. No. 25087-34-7; obtained |
| | as ESCORENE LL-5100.09 from ExxonMobil. |
| F88 | Poly(ethylene oxide)-polypropylene oxide) block copolymer, CAS |
| | Reg. No. 9003-11-6; obtained as PLURONIC F 88 from BASF. |
| TDP | Triisodecyl phosphite, CAS Reg. No. 25448-25-3; obtained as TDP |
| | from Chemtura. |
| TDTBPP | Tris(2,4-di-t-butylphenyl) phosphite, CAS Reg. No. 31570-04-4; |
| | obtained as IRGAFOS 168 from Ciba Specialty Chemicals. |
| HIPS | High-impact polystyrene (rubber-modified polystyrene) having a |
| | polystyrene content of about 90 weight percent and a polybutadiene |
| | content of 10 weight percent; obtained as FX510 from NOVA Chemicals. |

Compositions are summarized in Table 2, where component amounts are expressed in parts by weight. Components were compounded in a 30 millimeter internal diameter twin-screw extruder operating at 300 rotations per minute with barrel temperatures of 240 to 290° C. from feedthroat to die. All components except for the polyethylene (LLDPE) and flame retardant were added at the feedthroat of the extruder. Polyethylene was added downstream of the feedthroat, and the aryl phosphate flame retardant (BPADP or RDP) was added further downstream via a liquid injector in the second half of the extruder. The extrudate was pelletized, and the pellets dried at 80° C. for four hours prior to subsequent use for injection molding.

The compositions were injection molded into articles for physical testing. Injection molding was conducted on a Van Dorn 120T injection molding machine using barrel temperatures of 530° F. (266.7° C.) and a mold temperature of 190° F. (87.7° C.).

Physical properties are summarized in Table 2. Values of flexural modulus and flexural stress at 5% strain, both expressed in units of megapascals, were measured at 23° C. according to ASTM D790-10. Heat deflection temperature values, expressed in degrees centigrade, were measured according to ASTM D648-07, Method B, using a sample thickness of 3.2 millimeters and a load of 1.8 megapascals. Notched Izod impact strength values, expressed in units of joules per meter, were measured at 23° C. according to ASTM D256-10. Multiaxial impact properties, reported as Energy to Maximum Load, Energy to Failure, and Total Energy, all expressed in units of joules, were measured at 23° C. according ASTM D3763-10e1; the Maximum Load associated with the Energy to Maximum Load is also reported in units of kilonewtons. Tensile modulus values, expressed in units of megapascals, tensile stress at yield values, expressed in units of megapascals, tensile elongation at yield values, expressed in units of percent, tensile elongation at break values, expressed in units of percent, were measured at 23° C. according to ASTM D638-10. Vicat softening temperature was measured according to ISO 306, under a load of 50 Newtons, at an initial temperature of 23° C., which was raised at a rate of 120° C. per hour. Melt mass-flow rates, expressed in units of grams per 10 minutes, were measured at 280° C. and 5 kilogram load according to ASTM D1238-10.

TABLE 2

| | | | | |
|---|---|---|---|---|
| C. Ex. A | C. Ex. B | C. Ex. C | C. Ex. D | Ex. 1 |

COMPOSITIONS

| | | | | | |
|---|---|---|---|---|---|
| PPE 0.46 | 50.45 | 55.92 | 0 | 0 | 0 |
| PPE 0.40 | 0 | 0 | 61.00 | 54.59 | 57.73 |
| Hydrocarbon Resin | 0 | 0 | 3.00 | 0 | 3.01 |
| ZnS | 0.12 | 0.12 | 0 | 0.12 | 0 |
| ZnO | 0.12 | 0 | 0 | 0.12 | 0 |
| MgO | 0 | 0.25 | 0 | 0 | 0 |
| BPADP | 0 | 0 | 0 | 17.00 | 15.55 |
| RDP | 16.68 | 13.63 | 14.60 | 0 | 0 |
| SEBS | 0 | 0 | 2.00 | 0 | 2.01 |
| SBS | 2.44 | 1.65 | 0 | 1.60 | 0 |
| T-SAN | 0.11 | 0.10 | 0.10 | 0.24 | 0.10 |
| LLDPE | 1.22 | 1.23 | 1.50 | 0.98 | 1.50 |
| F88 | 0 | 0.42 | 0 | 0 | 0 |
| TDP | 0.41 | 0.41 | 0 | 0 | 0 |
| TDTBPP | 0 | 0 | 0.20 | 0.40 | 0.20 |
| HIPS | 28.50 | 26.31 | 18.00 | 24.95 | 19.90 |
| total | 100.05 | 100.04 | 100.40 | 100.00 | 100.00 |

PROPERTIES

| | | | | | |
|---|---|---|---|---|---|
| Flexural Modulus | 2,550 | 2,650 | 2,580 | 2,880 | 2760 |
| Flex Stress at 5% Strain | 91.7 | 95.4 | 96.0 | 108 | 107 |
| HDT at 1.8 MPa | 80.1 | 92.2 | 97.4 | 93.9 | 95.0 |
| (3.2 mm bar) | | | | | |
| Notched Izod Impact | 249 | 206 | 144 | 94.2 | 145 |
| Energy to max load | 40.6 | 38.7 | 41.9 | 19.3 | 29.5 |
| Energy to failure | 53.2 | 50.6 | 53.2 | 24.8 | 40.3 |
| Energy, Total | 53.3 | 55.8 | 55.1 | 27.0 | 46.8 |
| Max Load | 4.92 | 4.89 | 4.96 | 4.07 | 4.63 |
| Modulus of Elasticity | 2,232 | 2,360 | 2,280 | 2,520 | 2777.5 |
| Tensile Stress at Yield | 59.3 | 62.6 | 66 | 68.7 | 67.7 |
| Elongation at Yield | 4.0 | 4.1 | 4.4 | 4.4 | 4.3 |
| Elongation at Break | 20 | 22 | 15 | 9.7 | 13 |
| Vicat at 50N/120° C. | 108 | 119 | 124 | 121 | 120 |
| MFR at 280° C., | 23.5 | 14.4 | 27.7 | 34.5 | 32.6 |
| 5 kg load | | | | | |

The Example 1 composition exhibits improved melt flow versus Comparative Examples A and B, improved heat deflection temperature versus Comparative Example A, and improved impact strength (both notched Izod impact strength and multi axial impact strength) versus Comparative Example D.

Hydrolysis resistance was evaluated as follows. Samples of pellets from Example 1 and Comparative Examples A, B and C were tested for melt volume-flow rate according to ISO 1133-2005, Procedure B, at a temperature of 280° C., an applied load of 5 kilograms. Additional pellets of the same compositions were exposed to 100% humidity at 95° C. for two weeks and tested for melt volume-flow rate. The percent change in melt volume rate after aging was calculated and the results are reported in Table 3.

TABLE 3

| | MVR (cm³/10 min) | MVR (cm³/10 min) | |
|---|---|---|---|
| | before aging | after aging | Change (%) |
| C. Ex. A | 33.92 | 22.92 | 32 |
| C. Ex. B | 14.48 | 17.75 | 23 |
| C. Ex. C | 29.5 | 24.55 | 17 |
| Ex. 1 | 31.38 | 30.09 | 4 |

The Example 1 composition showed superior hydrolysis resistance over that of Comparative Example A, Comparative Example B, and Comparative Example C as indicated by a surprisingly lower percent change in melt volume-flow rate after exposure of pellets to 100% humidity at 95° C. for two weeks. The melt volume-flow rates (MVR) for the Comparative Examples A, B, C compositions decreased by 17 to 32% after the high heat and humidity aging. In contrast, the melt volume-flow rate of the Example 1 composition decreased by only 4%. In addition, ³¹P NMR testing of samples after the high temperature/high humidity exposure revealed significantly more organophosphate ester hydrolysis products in Comparative Examples A, B, and C than in Example 1. Comparative Example D, while not tested for hydrolysis resistance, exhibited substantially lower impact strength (objectively manifested as notched Izod impact strength, energy to maximum load, energy to failure, and total energy) than Example 1.

These examples show that it is possible to improve the hydrolysis resistance of a poly(arylene ether) injection molding composition while substantially maintaining desired levels of melt flow, impact strength, and heat resistance.

All ranges disclosed herein are inclusive of the endpoints, and the endpoints are independently combinable with each other. Each range disclosed herein constitutes a disclosure of any point or sub-range lying within the disclosed range.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

1. A composition comprising:
about 53 to about 63 weight percent of a poly(arylene ether) having an intrinsic viscosity of about 0.34 to about 0.48 deciliter/gram measured at 25° C. in chloroform;
about 15 to about 25 weight percent of a rubber-modified polystyrene;
about 11 to about 18 weight percent of a bisphenol bis(diaryl phosphate); and
about 1 to about 4 weight percent of a hydrogenated block copolymer of an alkenyl aromatic compound and a conjugated diene;
wherein all weight percents are based on the total weight of the composition.

2. The composition of claim 1, wherein the poly(arylene ether) is a poly(2,6-dimethyl-1,4-phenylene ether) having an intrinsic viscosity of about 0.37 to about 0. 0.43 deciliter/gram measured at 25° C. in chloroform.

3. The composition of claim 1, wherein the bisphenol bis(diaryl phosphate) has the structure 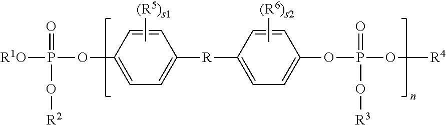
wherein R is independently at each occurrence a C₁-C₁₂ alkylene group; R⁵ and R⁶ are independently at each occurrence a C₁-C₅ alkyl group; R¹, R², and R⁴ are independently a C₆-C₁₂ unsubstituted or substituted aryl group; R³ is independently at each occurrence a C₆-C₁₂ unsubstituted or substituted aryl group; n is 1 to 25; and s1 and s2 are independently 0, 1, or 2.

4. The composition of claim 1, wherein the bisphenol bis(diaryl phosphate) comprises bisphenol A bis(diphenyl phosphate).

5. The composition of claim 1, wherein the hydrogenated block copolymer comprises a polystyrene-poly(ethylene-butylene)-polystyrene triblock copolymer.

6. The composition of claim 1, further comprising about 0.5 to about 3 weight percent of a mold release agent.

7. The composition of claim 6, wherein the mold release agent comprises linear low density polyethylene.

8. The composition of claim 1, further comprising about 0.02 to about 2 weight percent of a drip control agent.

9. The composition of claim 8, wherein the drip control agent comprises poly(styrene-acrylonitrile)-encapsulated polytetrafluoroethylene.

10. The composition of claim 1, further comprising about 0.5 to about 6 weight percent of a hydrocarbon resin.

11. The composition of claim 10, wherein the hydrocarbon resin comprises a hydrogenated aliphatic hydrocarbon resin.

12. The composition of claim 1, further comprising about 0.05 to about 1 weight percent of an aryl phosphite.

13. The composition of claim 12, wherein the aryl phosphite comprises tris(2,4-di-tert-butylphenyl)phosphite.

14. A composition comprising:
about 55 to about 60 weight percent of a poly(2,6-dimethyl-1,4-phenylene ether) having an intrinsic viscosity of about 0.37 to about 0.43 deciliter/gram measured at 25° C. in chloroform;
about 17 to about 23 weight percent of a high impact polystyrene;
about 13 to about 17 weight percent of bisphenol A bis(diphenyl phosphate);
about 1.5 to about 5 weight percent of a hydrogenated aliphatic hydrocarbon resin; and
about 1 to about 3 weight percent of a polystyrene-poly(ethylene-butylene)-polystyrene triblock copolymer;
wherein all weight percents are based on the total weight of the poly(arylene ether) composition.

15. The composition of claim 14, further comprising
about 0.5 to about 3 weight percent of a linear low density polyethylene;
about 0.05 to about 1 weight percent of tris(2,4-di-tert-butylphenyl)phosphite; and
about 0.02 to about 0.5 weight percent of a poly(styrene-acrylonitrile)-encapsulated polytetrafluoro ethylene.

16. An injection molded article comprising the composition of claim 1; wherein a portion of the injection molded article comprises
a first dimension of at least 10 centimeters,
a second dimension of at least 10 centimeters, and
a third dimension of less than 1 centimeter.

17. The injection molded article of claim 16, comprising the composition of claim 14.

18. The injection molded article of claim 16, wherein the injection molded article is a case for a lead acid battery.

19. A method of improving the hydrolytic stability of an injection molded article comprising a poly(arylene ether) composition, the method comprising:
injection molding the composition of claim 1 to form an injection molded article;
wherein a portion of the injection molded article comprises
a first dimension of at least 10 centimeters,
a second dimension of at least 10 centimeters, and
a third dimension of less than 1 centimeter.

20. The method of claim 19, wherein said injection molding comprising injection molding the composition of claim 14.

21. The method of claim 19, wherein the injection molded article is a case for a lead acid battery.
